(19) United States
(12) Patent Application Publication
(10) Pub. No.: US 2019/0385131 A1
(43) Pub. Date: Dec. 19, 2019

(54) VIRTUAL CURRENCY STORAGE AND TRANSACTION DEVICE

(71) Applicant: BEAUTIFUL CARD CORPORATION, Taoyuan City (TW)

(72) Inventor: MENG-JEN CHENG, TAOYUAN CITY (TW)

(21) Appl. No.: 16/010,767

(22) Filed: Jun. 18, 2018

(51) Int. Cl. G06Q 20/06; G06K 9/00

(52) U.S. Cl. CPC G06Q 20/065; G06K 9/00087

(57) ABSTRACT

A virtual currency storage and transaction device has a communication mechanism and a storage and transaction card connected thereto. The storage and transaction card has a card body, processor, power unit, fingerprint receiving unit, display unit and wireless communication unit. A virtual currency is supplied by the communication mechanism and stored in the processor. The communication mechanism withdraws the virtual currency from the processor and completes a transaction in the virtual currency. Storing the virtual currency and conducting the transaction therein involve receiving and recognizing a fingerprint with the fingerprint receiving unit and processor, connecting the wireless communication unit to the communication mechanism, and displaying related operation-related messages on the display unit, so as to eliminate security vulnerabilities effectively and thus render virtual currency storage and transaction safer.

### FIELD OF THE INVENTION

The present disclosure relates to virtual currency storage and transaction devices and, more particularly, to a virtual currency storage and transaction device for storage or transaction of virtual currency to eliminate security vulnerabilities effectively and thus render virtual currency storage and transaction safer.

### BACKGROUND OF THE INVENTION

According to prior art, people buy a virtual currency through the Internet, with communication mechanisms, such as personal computers, laptops, smartphones, and tablets, and then store the bought virtual currency on the communication mechanisms. Afterward, transactions are conducted in the virtual currency with the communication mechanisms again.

According to prior art, the virtual currency is stored on the communication mechanisms (or cloud hard disk drives). To conduct a transaction, owners of the virtual currency have to enter usernames and passwords into the communication mechanisms in order to withdraw the virtual currency from the communication mechanisms. However, the prior art has its drawbacks, as described below. Withdrawals of the virtual currency and ensuing transactions therein require no more than the owner's username and password, and thus the withdrawals and transactions are hardly safe. Furthermore, virtual currency storage is not safe either, because the virtual currency can be stolen in the event of a security vulnerability in the communication mechanisms or any online shop associated with the transactions. Examples of the security vulnerability include hacking, transaction record theft, stealing or cracking usernames and passwords.

Therefore, it is important to devise a virtual currency storage and transaction device for recognizing a virtual currency, storing the virtual currency on a storage and transaction card, withdrawing the virtual currency from the storage and transaction card, and conducting a transaction in the virtual currency, so as to eliminate security vulnerabilities effectively and thus render virtual currency storage and transaction safer.

### SUMMARY OF THE INVENTION

In view of the aforesaid drawbacks of the prior art, it is an objective of the present disclosure to provide a virtual currency storage and transaction device with a view to storing a virtual currency from a communication mechanism in a processor of a storage and transaction card and withdrawing the virtual currency from the processor with the communication mechanism for the sake of a transaction, so as to eliminate security vulnerabilities effectively and thus render virtual currency storage and transaction safer.

In order to achieve the above and other objectives, the present disclosure provides a virtual currency storage and transaction device, comprising a communication mechanism and a storage and transaction card. The communication mechanism supplies a virtual currency and completes a transaction in the virtual currency. The storage and transaction card connects to the communication mechanism to enable the virtual currency to be stored and withdrawn. The storage and transaction card comprises a card body, a processor disposed at the card body, a power unit disposed at the card body and electrically connected to the processor, a fingerprint receiving unit disposed at the card body and electrically connected to the processor, a display unit disposed at the card body and electrically connected to the processor, and a wireless communication unit disposed at the card body, electrically connected to the processor, and connected to the communication mechanism.

Regarding the virtual currency storage and transaction device, the processor comprises a safety module, a verification unit and a storage unit.

Regarding the virtual currency storage and transaction device, the power unit is a secondary battery or a primary battery.

Regarding the virtual currency storage and transaction device, the fingerprint receiving unit is a hard fingerprint receiving unit or a flexible fingerprint receiving unit.

Regarding the virtual currency storage and transaction device, the display unit has a flexible monitor, at least one luminous element, or a combination thereof.

Regarding the virtual currency storage and transaction device, the wireless communication unit has a Bluetooth communication interface, an NFC communication interface, or a combination thereof.

Regarding the virtual currency storage and transaction device, the storage and transaction card further comprises a rectify-stabilizing unit disposed at the card body and electrically connected among the processor, the power unit and the wireless communication unit.

Regarding the virtual currency storage and transaction device, the storage and transaction card further comprises an input unit disposed at the card body and electrically connected to the processor. The input unit is a leaf spring switch, a resistance touch switch, a capacitance touch switch or a fingerprint switch.

Therefore, the virtual currency storage and transaction device in preferred embodiments of the present disclosure comprises a communication mechanism. A virtual currency from the communication mechanism is stored in a processor of a storage and transaction card of the virtual currency storage and transaction device. The virtual currency is withdrawn from the processor with the communication mechanism to complete a transaction in the virtual currency. A process of storing the virtual currency and conducting a transaction therein requires a fingerprint receiving unit and the processor to receive and recognize a fingerprint. Upon confirmation that the fingerprint beings to a card holder, a wireless communication unit connects to the communication mechanism so as to perform the storage and transaction operation, whereas a display unit displays a related operation message. Accordingly, the virtual currency storage and transaction device in preferred embodiments of the present disclosure eliminates security vulnerabilities effectively and thus renders virtual currency storage and transaction safer.

### BRIEF DESCRIPTION OF THE DRAWINGS

FIG. 1 is a perspective view of a preferred embodiment of the present disclosure; and

FIG. 2 is a block diagram of a preferred embodiment of the present disclosure.

### DETAILED DESCRIPTION OF THE PREFERRED EMBODIMENTS

Objectives, features, and advantages of the present disclosure are hereunder illustrated with specific embodiments in conjunction with the accompanying drawings and described below.

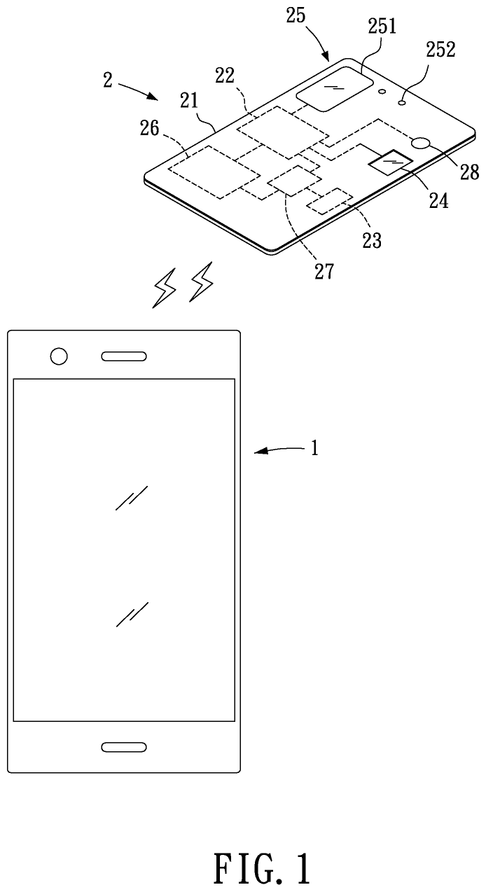

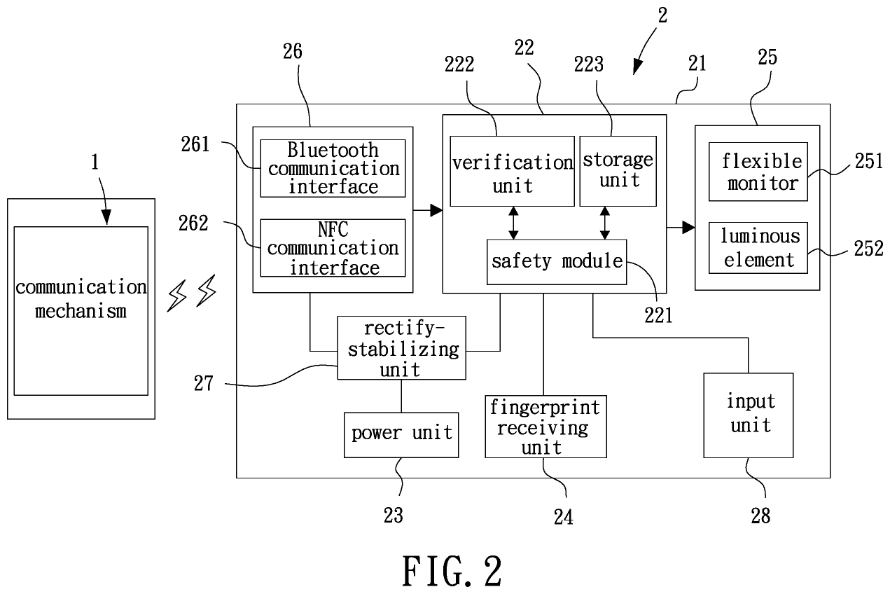

Referring to FIG. 1 and FIG. 2, the present disclosure provides a virtual currency storage and transaction device comprising a communication mechanism 1 and a storage and transaction card 2.

The communication mechanism 1 supplies a virtual currency and completes a transaction in the virtual currency. The communication mechanism 1 is a personal computer, laptop, smartphone, or tablet.

The storage and transaction card 2 connects to the communication mechanism 1 to enable the virtual currency to be stored and withdrawn. The storage and transaction card 2 comprises a card body 21, a processor 22 disposed at the card body 21, a power unit 23 disposed at the card body 21 and electrically connected to the processor 22, a fingerprint receiving unit 24 disposed at the card body 21 and electrically connected to the processor 22, a display unit 25 disposed at the card body 21 and electrically connected to the processor 22, and a wireless communication unit 26 disposed at the card body 21 and electrically connected to the processor 22.

The card body 21 carries the processor 22, the power unit 23, the fingerprint receiving unit 24, the display unit 25 and the wireless communication unit 26.

The processor 22 stores a card holder's fingerprint data, personal data, the virtual currency and transaction data, recognizes the card holder's fingerprints, stores the virtual currency, and performs computation related to a transaction conducted in the virtual currency.

The power unit 23 is a secondary battery or a primary battery to supply electric power required for operation of the processor 22, the fingerprint receiving unit 24, the display unit 25 and the wireless communication unit 26.

The fingerprint receiving unit 24 receives the card holder's fingerprint data.

The display unit 25 displays prompts indicative of fingerprint recognition, virtual currency storage, and a virtual currency-based transaction, respectively.

The wireless communication unit 26 connects to the communication mechanism 1.

A process of storing the virtual currency requires the card holder to fetch the virtual currency with the communication mechanism 1 and then touch the fingerprint receiving unit 24 with a finger configured for fingerprint recognition. Afterward, the process of storing the virtual currency requires the finger's fingerprint to be received by the fingerprint receiving unit 24, recognized and verified by the processor 22. Upon verification that the fingerprint belongs to the card holder, the display unit 25 outputs a confirmation message, such as a visual signal or a text message. Afterward, the processor 22 starts the wireless communication unit 26 such that the wireless communication unit 26 connects to the communication mechanism 1, allowing the storage and transaction card 2 to perform handshake with the communication mechanism 1. As a result, the virtual currency from the communication mechanism 1 is stored in the processor 22, and the display unit 25 outputs a storage status message, such as a visual signal or a text message, to inform the card holder that the virtual currency is being stored or has been stored. Therefore, the virtual currency from the communication mechanism 1 is stored in the processor 22 of the storage and transaction card 2 to render virtual currency storage safer by elimination of security vulnerabilities which might otherwise lead to theft of the virtual currency from the communication mechanism 1.

A process of conducting a transaction in the virtual currency requires the card holder to touch the fingerprint receiving unit 24 with a finger configured for fingerprint recognition. After the fingerprint receiving unit 24 has received the finger's fingerprint, the processor 22 recognizes and verifies the fingerprint. If the processor 22 confirms that the fingerprint belongs to the card holder, the display unit 25 outputs confirmation message, such as a visual signal or a text message, and the processor 22 starts the wireless communication unit 26 such that the wireless communication unit 26 connects to the communication mechanism 1, allowing the storage and transaction card 2 to perform handshake with the communication mechanism 1. As a result, the card holder operates the communication mechanism 1 to withdraw the virtual currency from the processor 22 in order to conduct a transaction. The display unit 25 outputs a transaction status message, such as a visual signal or a text message, to inform the card holder of the completion of the transaction conducted in the virtual currency. Therefore, the card holder can conduct a transaction in the virtual currency with the communication mechanism 1 and the storage and transaction card 2 to render virtual currency storage safer by elimination of security vulnerabilities which might otherwise lead to theft of the virtual currency from the communication mechanism 1.

Regarding the storage of or transaction in the virtual currency, if the fingerprint receiving unit 24 confirms that the fingerprint does not belong to the card holder, the processor 22 will send an error message, and the display unit 25 will automatically output an error message, such as a visual signal or a text message; as a result, the processor 22 does not take any action, or the processor 22 shuts down, so as to render the virtual currency transaction safer.

In an embodiment of the present disclosure, the processor 22 comprises a safety module 221, a verification unit 222 and a storage unit 223. The safety module 221 performs fingerprint recognition, virtual currency storage and computation related to a virtual currency-based transaction. The verification unit 222 operates in conjunction with the safety module 221 to receive fingerprint data from the fingerprint receiving unit 24 and verify the fingerprint data. The storage unit 223 stores the card holder's fingerprint data, personal data, the virtual currency and transaction data, so as to render the virtual currency storage and transaction safer.

In an embodiment of the present disclosure, the fingerprint receiving unit 24 is a hard fingerprint receiving unit or a flexible fingerprint receiving unit. In this regard, the card body 21 is either variable or used as needed, so as for the present disclosure to meet practical user needs.

In an embodiment of the present disclosure, the display unit 25 has a flexible monitor 251, at least one luminous element 252, or a combination thereof. The present disclosure is exemplified by an embodiment which requires the flexible monitor 251 and at least one luminous element 252. The storage unit 223 is preconfigured with a display mode of the flexible monitor 251 such that the flexible monitor 251 outputs a related text message. The luminous element 252 is an LED. During a manufacturing process of the virtual currency storage and transaction device, the storage unit 223 is preconfigured with a display mode of the luminous element 252. Examples of the display mode include continuous lighting, flashing, recurring lighting, or changing color. Hence, the luminous element 252 outputs a related message, so as to meet various needs for a display status.

In an embodiment of the present disclosure, the wireless communication unit 26 has a Bluetooth communication interface 261, an NFC communication interface 262, or a combination thereof. The present disclosure is exemplified by an embodiment which requires both the Bluetooth communication interface 261 and the NFC communication interface 262. Hence, the Bluetooth communication interface 261 connects to the communication mechanism 1 so as to effect storage of the virtual currency, whereas the NFC communication interface 262 connects to the communication mechanism 1 so as to effect a transaction conducted in the virtual currency, thereby meeting the need for variable connections.

In an embodiment of the present disclosure, the storage and transaction card 2 further comprises a rectify-stabilizing unit 27 disposed at the card body 21 and electrically connected among the processor 21, the power unit 23 and the wireless communication unit 26. The rectify-stabilizing unit 27 stabilizes the operating voltage of the power unit 23 and precludes any unstable voltage which might otherwise damage the processor 22.

In an embodiment of the present disclosure, the storage and transaction card 2 further comprises an input unit 28. The input unit 28 is disposed at the card body 21 and electrically connected to the processor 22. The input unit 28 is a leaf spring switch, a resistance touch switch, a capacitance touch switch or a fingerprint switch. The input unit 28 not only gains access to electric power and then starts the processor 22 and the fingerprint receiving unit 24 to therefore exercise control over fingerprint recognition, but is also conducive to user-related configuration of the processor 22, so as to meet various needs for use status and manufacturing.

The present disclosure is disclosed above by preferred embodiments. However, persons skilled in the art should understand that the preferred embodiments are illustrative of the present disclosure only, but shall not be interpreted as restrictive of the scope of the present disclosure. Hence, all equivalent modifications and replacements made to the aforesaid embodiments shall fall within the scope of the present disclosure. Accordingly, the legal protection for the present disclosure shall be defined by the appended claims.

What is claimed is:

1. A virtual currency storage and transaction device, comprising:
a communication mechanism for supplying a virtual currency and completing a transaction in the virtual currency; and
a storage and transaction card connected to the communication mechanism to enable the virtual currency to be stored and withdrawn, wherein the storage and transaction card comprises a card body, a processor disposed at the card body, a power unit disposed at the card body and electrically connected to the processor, a fingerprint receiving unit disposed at the card body and electrically connected to the processor, a display unit disposed at the card body and electrically connected to the processor, and a wireless communication unit disposed at the card body, electrically connected to the processor, and connected to the communication mechanism.

2. The virtual currency storage and transaction device of claim 1, wherein the processor comprises a safety module, a verification unit and a storage unit.

3. The virtual currency storage and transaction device of claim 1, wherein the power unit is a secondary battery or a primary battery.

4. The virtual currency storage and transaction device of claim 1, wherein the fingerprint receiving unit is a hard fingerprint receiving unit or a flexible fingerprint receiving unit.

5. The virtual currency storage and transaction device of claim 1, wherein the display unit has a flexible monitor, at least one luminous element, or a combination thereof.

6. The virtual currency storage and transaction device of claim 1, wherein the wireless communication unit has a Bluetooth communication interface, an NFC communication interface, or a combination thereof.

7. The virtual currency storage and transaction device of claim 1, wherein the storage and transaction card further comprises a rectify-stabilizing unit disposed at the card body and electrically connected among the processor, the power unit and the wireless communication unit.

8. The virtual currency storage and transaction device of claim 1, wherein the storage and transaction card further comprises an input unit disposed at the card body and electrically connected to the processor, and the input unit is a leaf spring switch, a resistance touch switch, a capacitance touch switch or a fingerprint switch.
